(19) United States
(12) Patent Application Publication
(10) Pub. No.: US 2010/0033774 A1
(43) Pub. Date: Feb. 11, 2010

(54) Variable feeder tray capacity control

(75) Inventors: Paul Ridl, Lake in the Hills, IL (US); Alan P. Jenks, Elgin, IL (US); Brian J. Mitton, Mount Prospect, IL (US)

Correspondence Address: MCDERMOTT WILL & EMERY LLP, 600 13TH STREET, N.W., WASHINGTON, DC, 20005-3096, US

(73) Assignee: BOWE BELL + HOWELL SCANNERS L.L.C.

(21) Appl. No.: 12/149,550

(22) Filed: May 5, 2008

(51) Int. Cl. H04N 1/04; B65H 1/00

(52) U.S. Cl. 358/498; 271/145

(57) ABSTRACT

The present subject matter relates to methods and systems for feeding sheets or batches of sheets, where a sheet feeder tray capacity level of a sheet feeder table is controllably varied through a hardware or software user interface, allowing a user to selectively set the sheet feeder table capacity level to any desired level according to a user's needs, and resulting in reduced overall batch feeding time and increased productivity as a result of less feeder tray movement during the feeding process. Control of the feeder tray capacity level through a user hardware interface is achieved by using “up” and “down” buttons or other keys on a control panel to adjust the feeder tray capacity level setting. A control panel button can also provide an automatic capacity setting feature. Control of the feeder tray capacity level through a user software interface is achieved by entering the desired feeder tray capacity level setting into a feeder tray capacity level setting box in the software control interface. The sheet feeder tray will be raised or lowered to a capacity level corresponding to the selected setting.

### TECHNICAL FIELD

The exemplary teachings herein pertain to methods and systems for feeding sheets, and in particular, to a sheet feeder system for a scanner, printer, copier, facsimile, or the like, characterized by the improved feeding of sheets to such equipment. Specifically, the present disclosure relates to methods and systems for controlling feeder tray capacity when scanning sheets, to speed up or lessen the overall scanning process time in high speed image scanning equipment.

### BACKGROUND

It is well known in the art of imaging/printing equipment to use a sheet feeder system to support a stack of sheets, and to feed these sheets to the imaging/printing equipment, one at a time from the stack. Such sheet feeder systems typically include a feeder tray for supporting the stack of sheets, and a skimmer apparatus for separating the sheets in the stack from one another as they are transported into the imaging/printing equipment.

There are a number of known methods used to deliver the sheets from the stack and into the imaging/printing equipment one at a time. For example, in high speed image scanning equipment, the feeder tray can be raised to bring the stack of sheets into contact with the skimmer apparatus above the stack, which then repeatedly moves the top sheet into the scanning equipment, one at a time.

To scan a stack of sheets in this manner, the stack of sheets is placed into the feeder tray, which typically has a maximum capacity. Where the number of sheets in the stack of sheets is less than the maximum capacity of the feeder tray, the feeder tray initially must be raised until the stack of sheets comes into contact with the skimmer apparatus. For example, if the feeder tray capacity has a maximum capacity of 100 sheets, and the stack of sheets only has 50 sheets, the feeder tray must be raised from the 100 sheet level to the 50 sheet level before the scanning process can commence. The time it takes to raise the feeder tray from its maximum capacity level to this ready-to-scan level, however, results in a delay in the start of the scanning process, and thus, a loss of productivity. Where multiple stacks of sheets, or batches, must be scanned, this delay, and lost productivity, is multiplied.

In some high speed image scanning equipment, the feeder tray can be set to one of a small number of predetermined level settings. For example, the feeder tray level can be set to a maximum capacity of 100 sheets, 300 sheets or 500 sheets. Nonetheless, a delay in the scanning process will still occur, for example when the stack of sheets contains less than 100 sheets (for example 50 sheets), less than 300 sheets (for example 150 sheets), or less the 500 sheets (for example 350 sheets), respectively.

Accordingly, to address the above stated issues, a convenient means for controlling the feeder tray capacity level based upon a user's specific needs in order to lessen overall scanning process time and to maximize productivity is needed. Furthermore, the feeder tray capacity control capability must be easily invoked, on demand. Still further, it is preferred that the feeder tray capacity control capability be executable via a hardware interface, and thus, eliminating or reducing the need to access the feeder tray capacity control feature using the software interface to the scanner. It is desired that the methods and systems for providing the above benefits be applicable to any instances or applications wherein a feeder tray is required, including automated document feeding (ADF) systems and the like.

### SUMMARY

The exemplary technique(s), system(s) and method(s) presented herein relate to variably controlling feeder tray capacity through a user interface, to set the feeder capacity to any desired level according to a user's needs, and resulting in reduced overall scanning process time and increased productivity. An exemplary method includes the step of setting the feeder tray capacity level to a level corresponding to the largest stack size in a batch or batches of stacks of sheets to be scanned using an automatic document feeder.

In a preferred embodiment, control of the feeder tray capacity level is through a user hardware interface associated with the automated document feeder and/or image scanning equipment. The method includes determining the largest stack size in a batch or batches of stacks of sheets, and determining the current feeder tray capacity level setting. If the largest stack size is greater than the current feeder tray capacity level setting, the user hardware interface is used to lower the feeder tray to the capacity level corresponding to the largest stack size. If the largest stack size is less than the current feeder tray capacity level setting, the user hardware interface is used to raise the feeder tray to the capacity level corresponding to the largest stack size.

In another embodiment, control of the feeder tray capacity level is through a user software interface associated with the automated document feeder and/or image scanning equipment. The method includes determining the largest stack size in a batch or batches of stacks of sheets, and using the software interface to enter the feeder tray capacity level setting corresponding to the largest stack size. If the entered feeder tray capacity level setting is greater than the previous feeder tray capacity level setting, the software will lower the feeder tray to the capacity level corresponding to the entered setting. If the entered feeder tray capacity level setting is less than the previous feeder tray capacity level setting, the software will raise the feeder tray to the capacity level corresponding to the entered setting.

In addition to an automatic document feeder mode, the exemplary feeder preferably also includes a manual feeder mode. In the manual feeder mode, the feeder tray is raised to its full up position. Sheets can then be hand fed one at a time, or a mini stack of sheets can be placed on the feeder and automatically fed from the full up tray position.

Additional objects, advantages and novel features will be set forth in part in the description which follows, and in part will become apparent to those skilled in the art upon examination of the following and the accompanying drawings or may be learned by production or operation of the examples.

### BRIEF DESCRIPTION OF THE DRAWINGS

The drawing figures depict one or more implementations in accord with the present teachings, by way of example only, not by way of limitation. In the drawing figures, like reference numerals refer to the same or similar elements.

FIG. 1 depicts an exemplary scanner having an automated document feeding system for processing sheets;

FIG. 2 depicts the hardware user interface of the exemplary scanner system for FIG. 1 for exposing various capabilities, features and functions;

FIG. 3 depicts another exemplary scanner having an automated document feeding system for processing sheets, and having an alternate hardware user interface;

FIG. 4 depicts a graphical user interface for exposing various capabilities, features and functions of the exemplary scanner system of FIG. 1 or FIG. 3 to a user via a computer interface;

FIG. 5 is an exemplary depiction of a transport system of the exemplary scanner of FIG. 1 or FIG. 3;

FIG. 6 depicts a flow chart illustrating the positioning of the feeder tray during the operation of the exemplary scanner system of FIG. 1; and

FIGS. 7 and 8 are flow charts depicting the exemplary operation of a scanner device for variably controlling feeder tray capacity.

### DETAILED DESCRIPTION

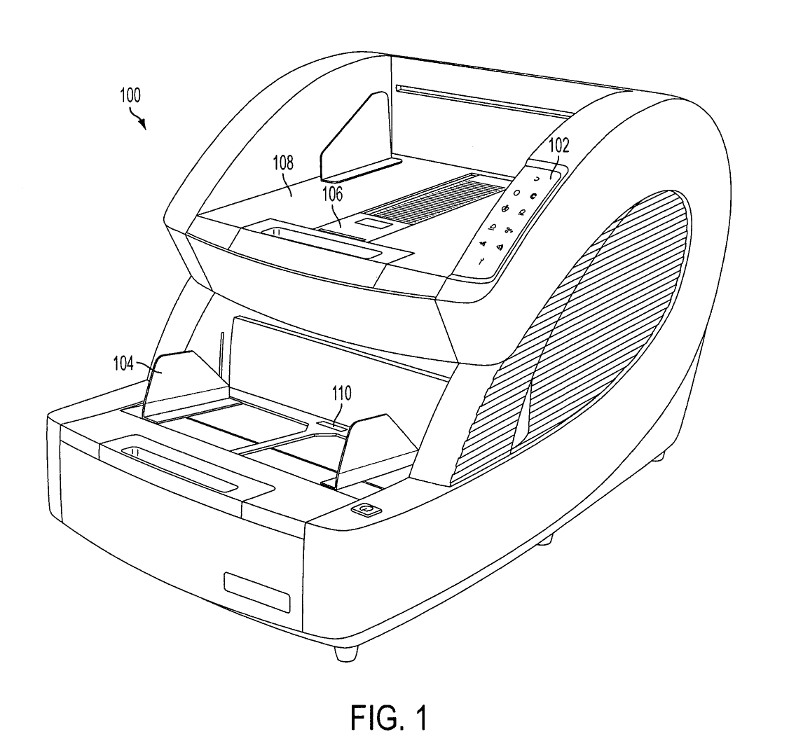

The following description refers to numerous specific details which are set forth by way of examples to provide a thorough understanding of the relevant teachings. It should be apparent to those skilled in the art that the present teachings may be practiced without such details. In other instances, well known methods, procedures, components, and circuitry have been described at a relatively high-level, without detail, in order to avoid unnecessarily obscuring aspects of the present teachings. It will be appreciated by those versed in the art that the exemplary teachings described herein enable the variable feeder tray capacity control capability of an automated document feeding device (e.g., scanner), allowing selective setting on demand by a user of said device. The description now proceeds with a discussion of FIGS. 1-8, which depict by way of example the following: an exemplary scanner device, its hardware control interface, another scanner device with an alternate hardware control interface, a software control interface for such scanner devices, a transport system for such scanner devices, a flow chart of the positioning of the feeder tray during use, and flow charts for the setting of the variable feeder tray capacity, respectively.

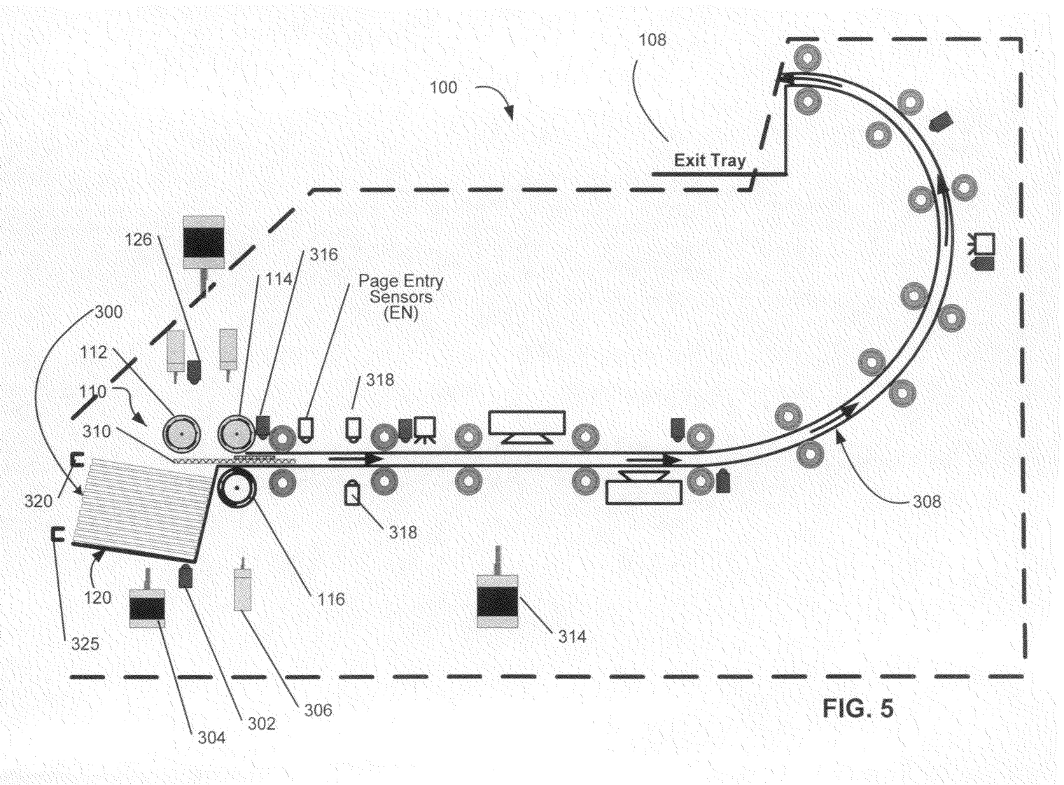

The exemplary scanner 100 of FIG. 1 is comprised of various functional components for facilitating and/or enabling its multitude of operating features. Entry into the transport system of the scanner 100, wherein the various scanning functions are performed upon the sheet (described in greater detail with respect to FIG. 5), is facilitated by usage of a sheet feed guide 104 and sheet feeder 110 (e.g., sheet input channel). The sheet feed guide 104 ensures correct placement of a sheet as it is fed to (and through) the transport system of the scanner by the sheet feeder 110. A tray or table (e.g., sheet feeder table 120 in FIG. 5) is typically provided for supporting multiple sheets or pages of a document underneath the sheet feeder 110. Also included is an exit tray 108 and sheet stop guide 106 for storing accumulated sheets upon full transport through the scanner 100 and for securing them in place respectively.

Other features of the scanner 100 include a control panel 102, which acts as a hardware interface to the scanner system 100 to enable the user to control basic operation. The control panel 102 may include various user buttons, dials, switches, controls or the like for enabling user access and control. In general, the control panel exposes various operational controls for enabling user and advanced control of the scanner system 100.

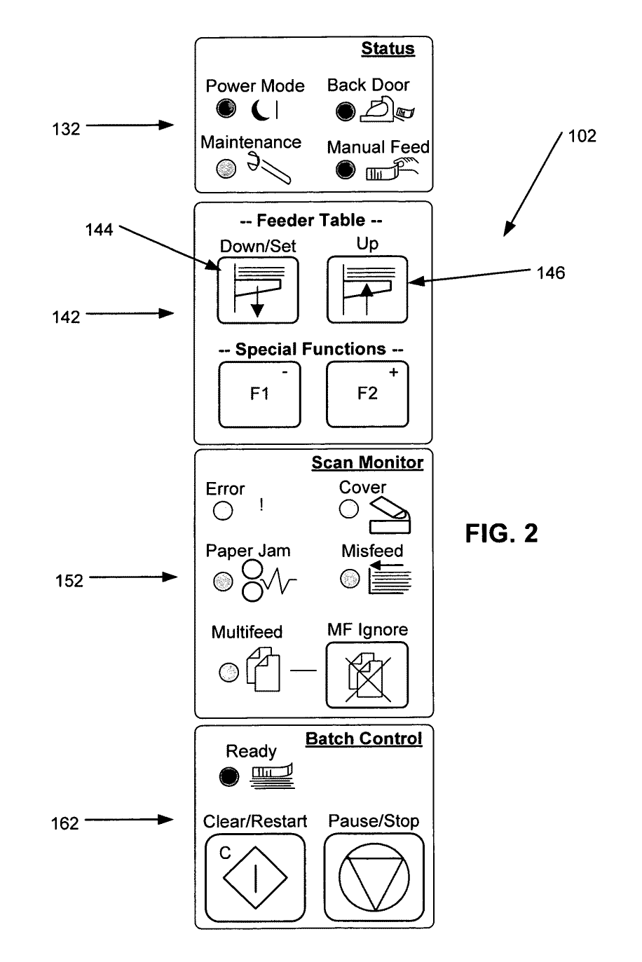

An exemplary control panel is illustrated in FIG. 2. This exemplary control panel provides status and control in four categories, namely, status area 132, feeder table area 142, scan monitor area 152 and batch control area 162.

In the status area 132, the example control panel indicators may include, but are not limited to, a power mode indicator to indicate if the scanner's power is either on or standby, a back door indicator to indicate if the scanner's back door is open, a maintenance indicator to indicate if the scanner needs maintenance, and a manual feed indicator to indicate if the scanner is in manual feed mode, as discussed in more detail below.

In the feeder table area 142, the example user buttons may include, but are not limited to, a tray down/set button 144 to move the feeder tray down to a new feeder tray capacity level or to set the tray capacity level, as discussed in more detail below, a tray up button 146 to move the feeder tray up to a new feeder tray capacity level, discussed in more detail below, and one or more special function keys (e.g., F1, F2) for launching programmed responses or programs. The set feature of button 144, used to set the current position of the tray as its new feeder tray capacity level as discussed in more detail below, could be associated with the up button 146 instead of button 144, or with both buttons 144 and 146. It should also be understood that the set feature could have its own, separate button.

In this preferred embodiment, each press of the down or up buttons will preferably result in a corresponding single movement in the feeder tray to a new capacity level. When one of the buttons is pressed and held down, the feeder tray capacity level setting will continuously, and more rapidly, change in the corresponding direction. Thus, for example, if the down button is pressed and held down, the feeder tray capacity level setting will quickly increase from its current level towards the maximum feeder tray capacity level until the down button is released. A feeder table elevator (FIG. 5) will lower the feeder table (FIG. 5) accordingly. One or more single presses of the down or up buttons can then be used to precisely set the feeder tray capacity level at the desired setting.

The feeder capacity level can be expressed in any suitable measurement. For example, the feeder capacity level can be expressed in a sheet count, e.g., 500 sheets. However, in general, feeder capacity is really in units of dimension rather than sheet count, since the number of sheets in a given stack height varies greatly due to sheet thickness and stacking characteristics. When a feeder is referred to as a “500 sheet” feeder, the implicit conditions for this count are 20 lb bond paper in a “fluffed” condition (i.e., with some inter-sheet air space, not tightly compressed such as in a fresh ream). A feeder capacity setting that could hold 500 sheets of fluffed bond would only be capable of containing maybe one third as many card stock sheets. Accordingly, the down and up buttons in the feeder table area 142 leave the capacity level unquantified. The user simply uses the buttons to drive the feeder tray anywhere the user wants to set the feeder tray capacity level.

It is noted that the disclosed method and system is particularly useful for input feeders on high speed scanning equipment. While the disclosed method and system can be used in connection with blank paper feeders, such as may be found on a typical printer or copier, it is usually desired to place the maximum load of blank paper in such blank paper feeders, and as such, the need for the disclosed method and system on blank paper feeders may be limited.

In the scan monitor area 152, the example control panel indicators may include, but are not limited to, an error indicator to indicate a scanning error, a cover indicator to indicate an opened cover, a paper jam indicator to indicate a paper jam, a misfeed indicator to indicate a sheet misfeed, and a multifeed indicator to indicate a multifeed. A Multifeed ignore button is also provided to allow the user to command the scanner to ignore the multifeed.

In the batch control area 162, the example control panel indicators and user buttons may include, but are not limited to, a ready indicator to indicate that the scanner is ready to scan a batch of sheets, a Clear/Restart button to start a scan, thus activating the scanner transport mechanism, and a Pause/Stop button to stop a scan, thus deactivating the scanner transport mechanism.

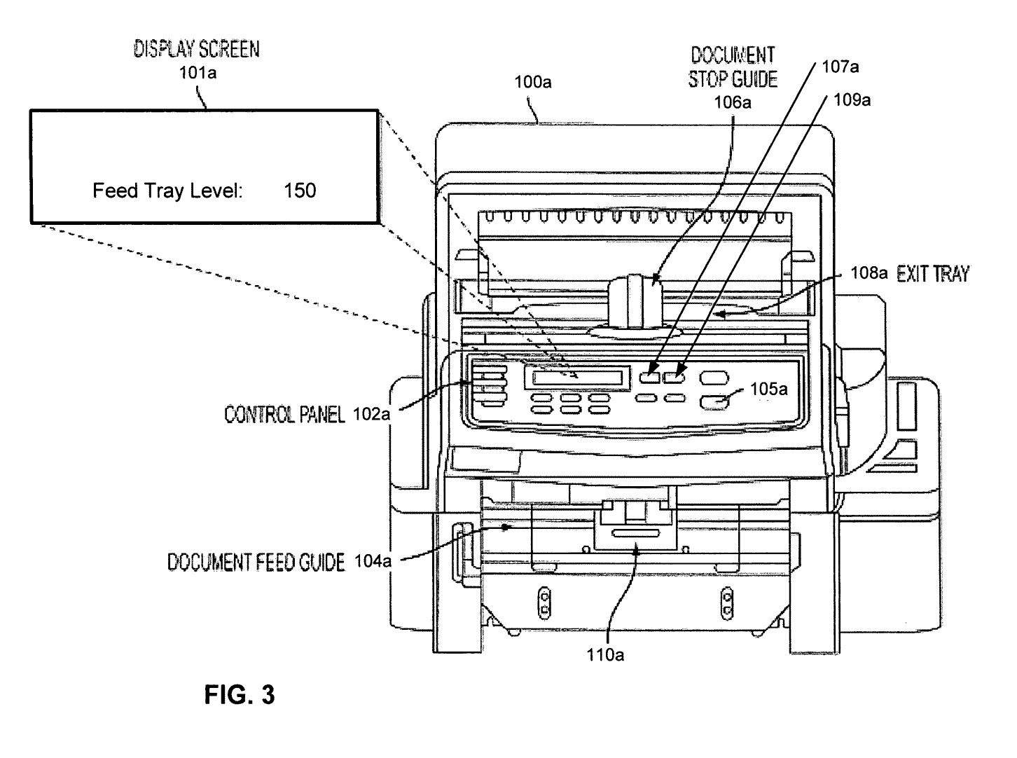

Referring now to FIG. 3, an alternate exemplary scanner 100a is comprised of various functional components for facilitating and/or enabling its multitude of operating features. Entry into the transport system of the scanner 100a, wherein the various scanning functions are performed upon the sheet (described in greater detail with respect to FIG. 5), is facilitated by usage of a sheet feed guide 104a and sheet feeder 110a (e.g., sheet input channel). The sheet feed guide 104a ensures correct placement of a sheet as it is fed to (and through) the transport system of the scanner by the sheet feeder 110a. A tray or table (e.g., sheet feeder table 120 in FIG. 5) is typically provided for supporting multiple sheets or pages of a document underneath the sheet feeder 110a. Also included is an exit tray 108a and sheet stop guide 106a for storing accumulated sheets upon full transport through the scanner 100a and for securing them in place respectively.

Other features of the scanner 100a include a control panel 102a, which acts as a hardware interface to the scanner system 100a to enable the user to control basic operation. The control panel 102a may include various user buttons, dials, switches, controls or the like for enabling user access and control. Example control panel user buttons may include, but are not limited to, one or more function keys for launching programmed responses or programs, a START/STOP scan button 105a for activating or deactivating the scanner transport mechanism, a document page count reset button, and scroll keys (e.g., scroll down button 107a and scroll up button 109a) for usage in connection with a display screen 101a. In general, the control panel exposes various operational controls for enabling user and advanced control of the scanner system 100a.

The scanner 100a may also include a display screen 101a, which may be implemented as a Liquid Crystal Display (LCD) for displaying multiple lines of data indicative of the status or mode of operation of the scanner during various phases of its operation. As an example of its display capability, the exemplary display panel 101a shows the feeder tray capacity level control submenu, a menu that shows the current setting of the feeder tray capacity level, expressed for example by number of sheets.

In use, one of the function keys on the control panel 102a will access the feeder tray capacity level control submenu. The feeder tray capacity level control submenu will display on the display screen 101a, the current setting of the feeder tray capacity level (e.g., 150 sheets). The scroll down button 107a and the scroll up button 109a can then be used to change the setting of the feeder tray capacity level. Pressing the scroll up button 109a will cause the feeder table elevator (FIG. 5) to raise the feeder table (FIG. 5). Pressing the scroll down button 107a will cause the feeder table elevator (FIG. 5) to lower the feeder table (FIG. 5).

While the exemplary teaching describe use of the scroll buttons to adjust the feeder tray capacity level setting, it should be understood that any suitable buttons or keys on the control panel could be designated and used to increase or decrease the feeder tray capacity level setting. Further, if the control panel has a numeric keypad, for example, the desired feeder capacity level setting could be entered directly by way of the numeric keypad.

In this embodiment, each press of the scroll buttons will preferably result in a corresponding single movement in the feeder tray capacity level (e.g., from the 150 sheet level to the 149 sheets level upon pressing the scroll up button). When the scroll buttons are pressed and held down, the feeder tray capacity level setting will continuously, and more rapidly, change in the corresponding direction. Thus, for example, if the scroll down button 107a is pressed and held down, the feeder tray capacity level setting will quickly increase from the 150 sheet level towards the maximum feeder tray capacity level (e.g., 500 sheets level) until the scroll down button is released (e.g., at the 405 sheets level). The feeder table elevator (FIG. 5) will lower the feeder table (FIG. 5) accordingly. One or more single presses of the scroll buttons can then be used to precisely set the feeder tray capacity level at the desired setting (e.g., 400 sheets level).

Again, since the sheet count capacity level is really in units of dimension, this capacity level could be expressed and displayed in another manner, such as a percentage (e.g., a 400 sheet capacity level would be 80% of a 500 sheet maximum capacity level), or a dimension such as inches (e.g., if a 500 sheet maximum capacity level is 5 inches down from the trays full up position, a 400 sheet capacity level would be 4 inches, etc.).

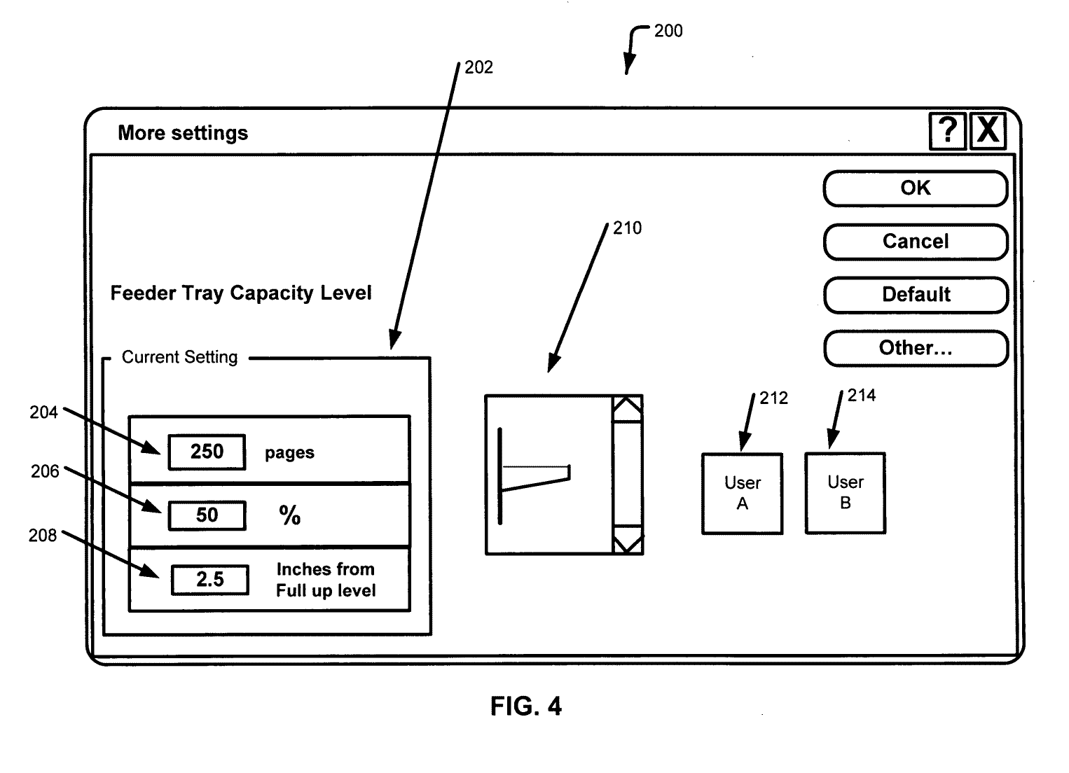

Generally, the exemplary scanner device 100 or 100a is also equipped with a software application/interface for enabling the manipulation of such advanced control features as discussed above. An exemplary software control interface 200 for an exemplary scanner as rendered by a computer graphical user interface is shown in FIG. 4. As a matter of convenience, the interface 200 can be invoked by the operator of the scanner as needed—i.e., as a standalone application or by way of another application, such as document editing software—and is graphically based for ease of use. It may have a window with various scanner control features, including a feeder tray capacity level setting box 202 for enabling a user to enter the desired feeder tray capacity level setting.

As this option is provided via the user interface, the operator would engage the feeder tray capacity level setting box using a mouse, keyboard or the like as a command input peripheral device. Suffice to say, it is well known to those skilled in the art that advanced control features and settings of a scanner are typically modified via the usage of such a software interface as depicted in FIG. 4. Still further, it is well known by those skilled in the art that operator access to the various control features and settings, while varying from one scanner control system to the next, may very well involve the invocation of a plurality of windows, menus, etc.

As discussed above, the feeder tray capacity level setting box 202 could express the capacity level setting in one or more ways, such as a sheet count level 204, a percentage level 206, or a dimensional measurement level (such as inches) 208. A graphical representation 210 of a feeder table can also be provided wherein the user could use a mouse to position the feeder table (in a drag and drop manner, and/or using a scroll bar) at a desired level. Where two or more of these setting controls 204-210 are displayed in software interface 200, changing the setting in one would automatically change the settings in the others.

Additionally, one or more profile setting selections (e.g. icons, buttons, etc.) can be provided corresponding to a preset feeder tray capacity level. For example, a User A profile setting 212 and a User B profile setting 214 can be displayed and selected. User A may have a preset capacity level at the 250 sheets level. Thus, selection of the User A profile setting would set the sheet count level 204 at 250 sheets, the percentage level 206 at 50%, the measurement level 208 at 2.5 inches, and the graphical representation 210 showing the feeder table half way or in the middle.

Turning now to FIG. 5, an exemplary internal depiction of the scanner transport system is shown, and particularly, the sheet feeder system comprising the sheet feeder 110 and the sheet feeder table 120 is depicted. The feeder table 120 is raised and lowered by feeder table lift/drive 304 as confined by upper limit sensor 320 and lower limit sensor 325, which prevent improper operation and/or damage to the sheet feeder system. The sheet feeder 110 comprises a pick roller 112, a feed roller 114, and a separator or retard roller 116. The pick roller 112 and feed roller 114 are commonly referred to collectively as a skimmer, which can be in one of three angled positions, an up position, a down position and a generally horizontal feed position. All three positions are measured by the skimmer angle sensor 126. All of these rollers in the sheet feeder 110 are preferably driven by the same motor, feed roller drive 306, although any number of drive systems could feasibly be used.

In an automatic document feeder (ADF) mode, the feeder tray lift/drive 304 is enabled to lift the feeder tray 120 and thus sheet stack 300 into the skimmer when the skimmer is in the down position or down skimmer angle. The sheet feeder 110 is enabled when the top sheet 310 in the stack 300 pushes the skimmer generally horizontal and places the skimmer angle in the neutral position. The sheet feeder 110 is disabled when the user lifts the skimmer and places the skimmer angle in the up position. The skimmer can be held in the up position by a magnet. When the skimmer angle is up, the feeder table lift/drive 304 is enabled to lower the feeder tray 120 back to its current capacity level setting.

Accordingly, in an automatic document feeder (ADF) mode, when a stack of one or more sheets 300 is placed onto the sheet feeder table 120, the paper in feeder sensor (PIF) 302 detects the presence of the sheet(s), and activates the feeder table lift/drive 304 which in turn lifts the stack 300 from the current feeder tray capacity level, and in the direction of sheet feeder 110 for input into the transport path 308. Upon receipt of a scan command, the sheet feeder 110 of the scanner moves the top page 310 of the stack of sheets 300, one at a time sequentially from the stack 300, using the feed roller drive 306, which drives the sheet feeder 110 to direct the top page 310 downstream through the transport path 308 via a system of various transport rollers. The transport rollers are regulated by a transport drive 314 (e.g., stepper motor), and are linked together via a transport belt, which also enables the pages of the stack of sheets 300 to be gripped for advancement down the transport path 308 appropriately, until they eventually reach the exit tray 108.

When all of the sheets in the stack of sheets 300 have been fed by the sheet feeder 110 into the transport path 308, the paper in feeder sensor 302 is unblocked, and the feeder table lift/drive 304 will lower the sheet feeder table 120 back to its current capacity level setting. The sheet feeder table 120 is then ready to receive the next stack of sheets to be scanned. As should be understood, because it takes time for the feeder tray to move, it takes longer to start a short stack of sheets at a maximum feeder tray capacity level, as well as time to return to this maximum feeder tray capacity level after the stack has been scanned.

For example, a 10 page stack placed in a feeder table set at a 500 sheet capacity level will require the feeder table to be raised from the 500 sheet level to the 10 sheet level, and then return to the 500 sheet level after the stack has been scanned, each taking several seconds. This results in wasted time and thus lost productivity. If a user has multiple stacks of sheets to scan (for example 25 stacks), with each stack having 10 pages, then this wasted time and productivity is multiplied according to the number of stacks (25 times). The lost seconds quickly add up to minutes, and even hours or more over a given period of time.

However, the variable feeder tray capacity control capability discussed herein substantially reduces and/or minimizes any such lost time/productivity by allowing a user to specifically adjust the level of the scanner's feeder tray prior to scanning, by setting the feeder tray capacity level to any desired level depending on the sheet batch size to be scanned. This advantageously reduces feeder tray up/down toggle time to maximize or optimize productivity. In the above example, the user would set the feeder tray capacity level at 10 pages. Thus, when scanning the 25 stacks of 10 pages each, the feeder tray need not be raised from or lowered to the 500 sheet level, and as such no time would be lost for unnecessary tray movement between the scanning of each of the 25 stacks. If another user had 9 stacks with 45 pages per stack, the feeder tray capacity level could be reset to 45 pages, and again no unnecessary tray movement time would be lost between scanning of each of these 9 stacks. If a user has multiple stacks of sheets of variable sizes (e.g. 12, 18, 15 and 10 sheets), the user could set the feeder capacity level to their maximum batch size (e.g. 18 pages) to minimize the movement of the feeder tray during the scanning of the multiple stacks, thus minimizing lost time/productivity.

Alternatively, the feeder tray capacity level could be continually adjusted during or between runs (feeding) of the batches, as illustrated by way of the following example. A user, for example, desires to feed three batches of documents or sheets having sizes of three inches, one inch and four inches respectively. The user can initially set the feeder tray capacity level to three inches using either the software interface 200 or buttons 144 and/or 146. While the first batch is running, the user can then enter or set the desired feeder tray capacity level for the second batch. To do so, the user can simply push and hold the set button 144 while the first batch is feeding when the tray reaches the desired capacity level. Thus, in this example, during feeding of the three inch stack, the user can push and hold button 144 when the tray reaches the one inch level. The tray will continue to rise until the three inch stack finishes feeding, and then will return to the one inch level instead of the three inch level. The user can then load the one inch stack and commence feeding of that batch. Alternatively, instead of using button 144, the user can simply use the software interface to set the capacity level for the one inch stack while the three inch stack is being fed.

Further, during the feeding of the one inch stack, the user can set the capacity level for the next batch, i.e., the four inch stack. Because the four inch stack is greater than the current one inch stack, the user will enter the desire setting (i.e., four inches) using the software interface. It is contemplated that the control panel 102 could have an indicator which would allow the user to set a greater capacity level for a subsequent batch via the control panel.

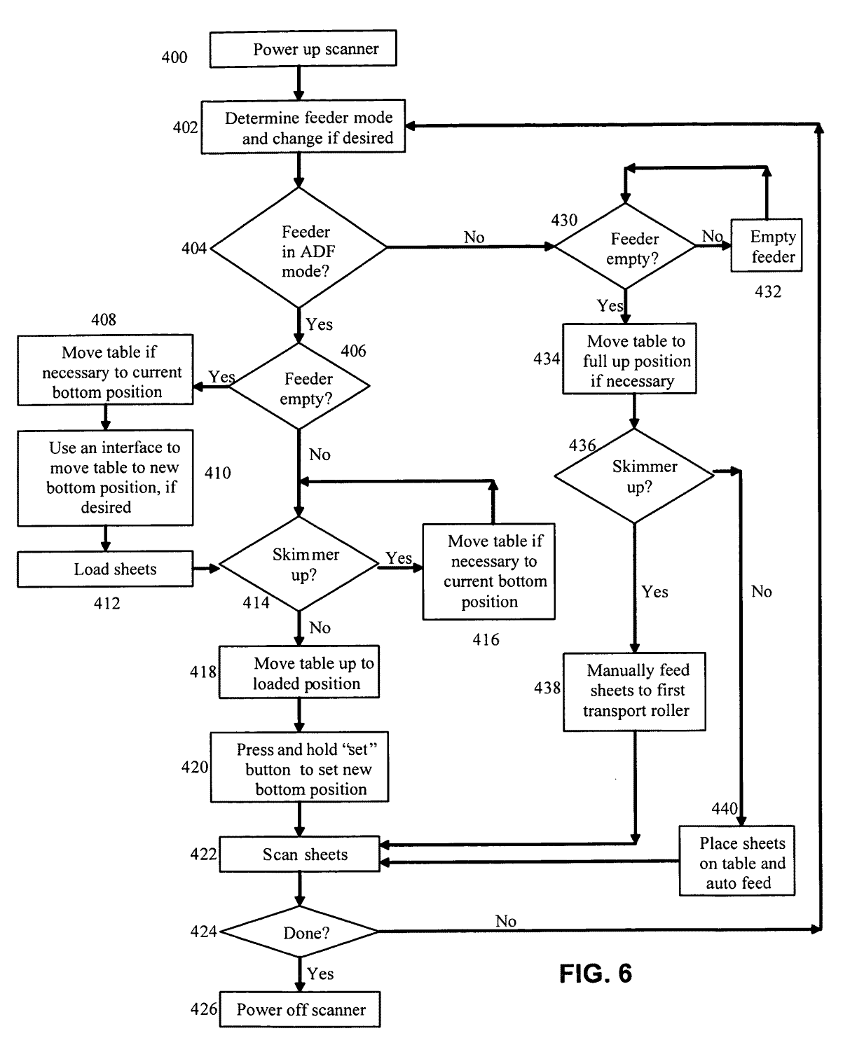

Referring now to FIG. 6, the movement of the feeder table 120 is described by way of an exemplary flow chart for the various scanner modes, skimmer angles, and paper in feeder conditions. The various movements of the feeder tray 120 are dependent on whether the scanner is in ADF mode or manual feed mode, and then dependent within each mode on whether there are sheets in the feeder tray and whether the skimmer is up or down. Thus, when the scanner is powered up, step 400, the scanner will determine if it is in ADF mode or manual feed mode, step 402.

The scanner mode can be changed by the user as desired. The mode is preferably set only via the imaging host driver (e.g., IC, ISIS, Twain), and not by control panel 102 selection. However, it should be understood that a mode selection option could be provided on the control panel 102 if desired. The manual feed indicator will light in the status area 132 on the control panel 102 when in manual feed mode. Preferably, ADF mode is the default mode, and as such, is not indicated on the control panel, although an indicator could be provided if desired. The particular mode setting of the scanner preferably sticks in the scanner's memory though power cycles. It should be understood however that the default ADF mode could be restored if desired upon each power cycle. Alternatively, it is foreseen that the user could set the default mode to any desired mode.

Accordingly, if at step 404 the scanner determines it is in ADF mode, the scanner will proceed to step 406 to determine whether or not the feeder tray is empty. If the feeder tray is empty, the feeder table will move to its current feeder tray capacity level setting, i.e., its current bottom position, step 408. This of course assumes that the feeder is not already at its current bottom position. At this time, the user can selectively use the down and up buttons in the feeder table area 142 of the control panel 102, or the software interface 200, to move the table to a new capacity level setting, i.e., new bottom position as desired, step 410. Once the feeder table is in the desired position, one or more sheets can be placed on the feeder table, step 412.

Once the sheets are loaded, step 412, or if the feeder was not empty at step 406, the scanner will determine whether or not the skimmer is in its up position, step 414. If the skimmer is up, the feeder table will move towards its current feeder tray capacity level setting, i.e., its current bottom position, step 416, until the skimmer is placed in its down position. This movement of course assumes that the feeder is not already at its current bottom position.

Preferably, the speed at which the feeder table is lowered depends on the reason why it is being lowered. When the feeder table is dropped after feeding the last page of a stack, then the maximum possible speed is always used to return to the current bottom position as soon as possible. There is no downside to this fastest possible motion as it is desirable to get the table ready for the next batch (stack) as soon as possible. However, when the table is dropped because the user lifted the skimmer, thereby taking the feeder out of service, the downward speed is ramped up, starting from a slower speed and increasing speed as the travel towards the current bottom position progresses. The reason for this is that often the skimmer is being lifted in order to straighten the top pages in a stack, with the intent of immediately dropping the skimmer again to continue scanning. In such a case, immediately starting at the more drastic downward speed is not a pleasing/desirable machine response to the user's motion. Such immediate downward speed would result in a jerky motion, and would tend to overshoot what downward travel the user needs to gain a bit of space and time to properly ready the stack, with any overshoot requiring additional wasted time to return to the “ready to feed” position.

When the skimmer is in its down position, the scanner will proceed to move the table up to its loaded, ready to feed, position, step 418. At this time, after a stack of some arbitrary size has been loaded into the feeder and has been raised to the ready-to-feed position, the user can press and hold the down button (or some other predetermined button) in the feeder table area 142 of the control panel 102 if desired, and after a predetermined amount of time, e.g. two seconds of continuous button holding, the capacity level setting will be automatically updated based on this stack size, step 420. Preferably, this automatic capacity setting feature does not use the exact current table position as the new bottom position, but adds a bit of extra dimension or space based on what loading clearance is desirable to comfortably load a stack of this size. For example, if the arbitrary size of the stack was 180 sheets, the capacity setting will be automatically set at, for example, 185 sheets or 190 sheets, etc. In this way, the user can optimize the table position for any specific actual stack. Of course, the current position must be able to accommodate the new stack size in order to be able to learn it. It is foreseen that this automatic capacity setting feature could also be invoked from the software interface, for example by communicating a “learn next batch size” command.

Once in the loaded, ready to feed position, the scan operation commences, step 422. After the entire stack has been scanned, at step 424, the user determines if there are additional stacks to scan. If so, the flow chart returns to step 402. If not, the scanner power would go to standby or be turned off, step 426.

Referring now back to step 404, if the scanner determines it is in manual feed mode, the scanner will proceed to step 430 and determine whether or not the feeder tray is empty. If the feeder tray is not empty, then manual mode is not ready, and the feeder tray must be emptied, step 432. Preferably, in this situation, the feeder table will not move, and the user would simply lift the skimmer and remove the sheets from the feeder tray to empty the feeder tray. At this time, the empty feeder table would move to its full up position and stay there, step 434. Alternatively, if the skimmer is down and the feeder table is not empty, the feeder table can be raised to the loaded position and the sheets can be auto-fed. When all of the sheets in the stack have been fed, then the feeder table would move to its full up position and stay there, step 434.

Once the feeder table is in its full up position and the feeder tray is empty, the scanner will determine whether or not the skimmer is in its up position, step 436. If the skimmer is in its up position, the scanner will enter its hand-feed manual submode. In this submode, the separator roller 116 is automatically dropped to allow pages to be moved through the separation nip and into the first transport roller pair. Sheets can then be manually fed to the first transport roller pair, step 438. After the all desired sheets have been manually fed, they are scanned at step 422. Then, at step 424, the user determines if there are additional sheets to scan. If so, the flow chart returns to step 402. If not, the scanner power would go to standby or be turned off, step 426.

If, however, at step 436, the scanner determines the skimmer is not in its up position, the scanner will enter its assisted manual submode. In this submode, the separator roller 116 is engaged as in ADF mode, although an optional configuration would allow the user to selectively drop the separator roller if desired. When sheets are placed on the feeder table, the sheets are fed as in ADF mode, step 440. In this way, assisted manual mode can feed mini-batches of multiple pages with no table drop or batch restart delay. After all the desired sheets have been fed, they are scanned at step 422. Then, at step 424, the user determines if there are additional sheets to scan. If so, the flow chart returns to step 402. If not, the scanner power would go to standby or be turned off, step 426.

In manual feed mode, the Ready indicator in the batch control area 162 of control panel 102 will blink several times (and remain lit) along with an audio prompt when scan commands are first queued to prompt for the start of a batch. The scan commences upon the user pushing the Clear/Restart button in batch control area 162 of control panel 102.

Accordingly, it should be understood from the above that for systems that employ automated document feeding (ADF) capability such as scanners or printers, it would be advantageous to have a feeder tray capacity level control capability. The exemplary teachings present a system and methodology for enabling feeder tray capacity control capability, either at the push of a button, switch, etc. via the control panel 102 (hardware interface) to accommodate differing sized batches of sheets to be scanned, or via the software interface 200. The convenient use of the hardware interface eliminates the need for the operator to access and navigate through multiple software interface menus or submenus to set the feeder tray capacity level.

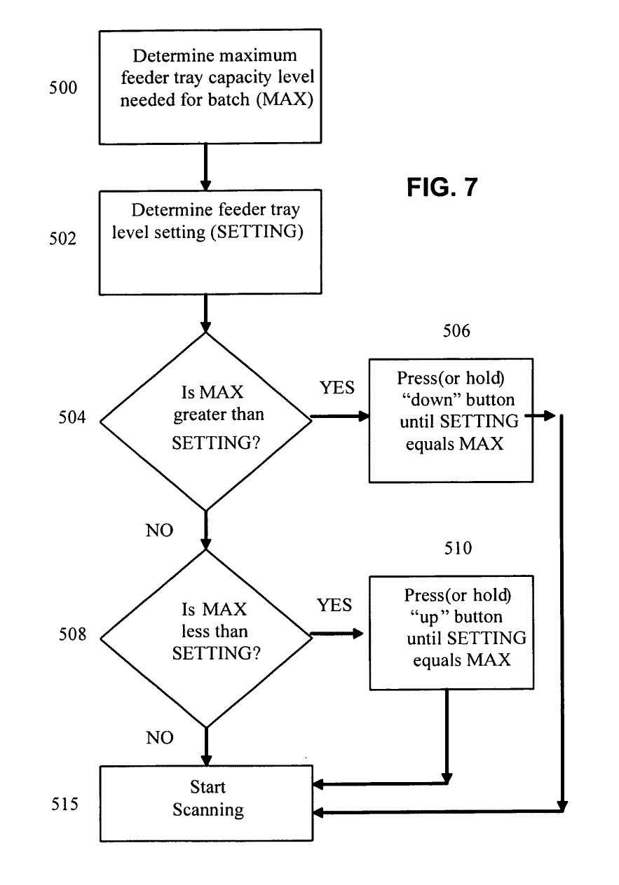

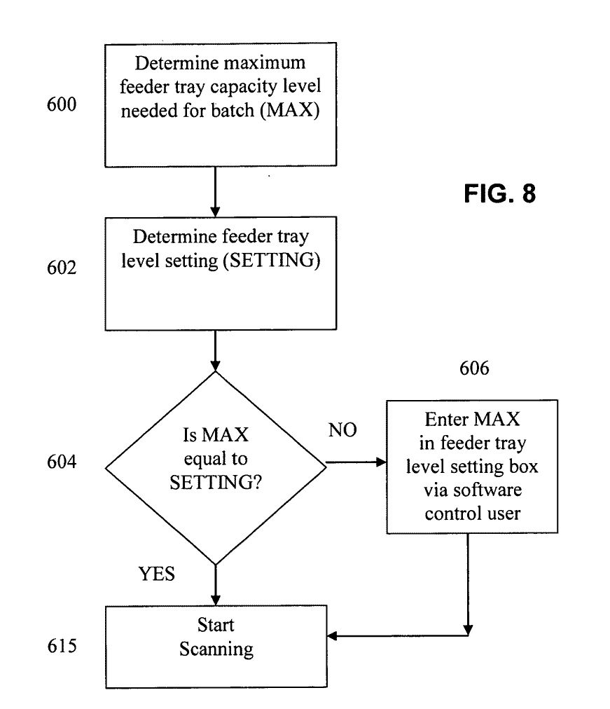

Nonetheless, either interface can be used at step 410 to set the capacity level. The first scenario, i.e., use of the hardware interface, is presented in FIG. 7 by way of example as a flowchart. The second scenario, i.e., use of the software interface, is presented by way of example as the flowchart of FIG. 8.

Turning now to FIG. 7, a user having a batch (multiple stacks) of sheets to be scanned can use the variable feeder capacity level control capability through the hardware interface as follows. Initially, the user must determine the maximum feeder tray capacity level (MAX) needed for the batch, i.e., the size of the largest stack of sheets in the batch to be scanned (step 500). This maximum (MAX) can be an estimate, so long as the estimate exceeds the actual size of the largest stack. Although to optimize, the maximum (MAX) would be equal to the size of the largest stack.

Once the maximum (MAX) is determined by the user, the user will determine the current feeder tray capacity level setting (SETTING) (step 502). To make this determination, the user simply need look at the current feeder tray position. Alternatively, the current feeder tray capacity level can be displayed on an optional display screen 101.

Next, the user compares the maximum (MAX) to the current feeder tray capacity level SETTING to determine whether the maximum number (MAX) is greater than the current SETTING (step 504) or less than the current SETTING (step 508). It is noted that for purposes of illustration step 504 comes first in the flow chart of FIG. 7, but these steps 504 and 508 can be done in any order. In reality, these steps 504 and 508 are essentially done simultaneously.

If the maximum (MAX) is greater than the current SETTING, then the user will press the down button in feeder table area 142 of control panel 102, until the SETTING equals the maximum (MAX) (step 506). This will cause the feeder table lift/drive 304 to lower the feeder table 120 to the user selected new SETTING for the feeder tray capacity level. As discussed above, the down button can be repeatedly pressed to move the feeder table incrementally, or held down to quickly move to the desired SETTING and then moved incrementally if needed to reach the desired SETTING.

If the maximum (MAX) is less than the current SETTING, then the user will press the up button until the SETTING equals the maximum (MAX) (step 510). This will cause the feeder table lift/drive 304 to raise the feeder table 120 to the user selected new SETTING for the feeder tray capacity level. As discussed above, the up button can be repeatedly pressed to move the feeder table incrementally, or held down to quickly scroll to the desired SETTING and then moved incrementally if needed to reach the desired SETTING.

Once the desired new SETTING is achieved through either step 506 or 510, the user can place the first stack of sheets in the feeder tray 120 and start the scanning process (step 515). If the current SETTING as determined at step 502 is already equal to the maximum number (MAX) as determined at step 500, the answer at both steps 504 and 506 is “NO” and the user can proceed to the start scanning step 515, without having to change the SETTING of the feeder tray capacity level. Alternatively, the user can use the automatic capacity setting feature of step 420 described above.

Turning now to FIG. 8, a user having a batch (multiple stacks) of sheets to be scanned can use the variable feeder capacity level control capability through the software interface as follows. Initially, the user must determine the maximum feeder tray capacity level (MAX) needed for the batch, i.e., the largest stack of sheets in the batch to be scanned (step 600). This maximum can be an estimate, so long as the estimate exceeds the actual size of the largest stack. Although to optimize, the maximum (MAX) would equal the size of the largest stack.

Once the maximum number (MAX) is known to the user, the user will determine the current feeder tray capacity level setting (SETTING) (step 602). To make this determination, the user simply need look at the feeder tray capacity level setting box 202 in the software control interface 200, which will indicate the level at which the feeder tray 120 is currently set.

Next, the user compares the maximum (MAX) to the current feeder tray capacity level SETTING to determine whether the maximum (MAX) is equal to the current SETTING (step 604). If the maximum (MAX) is equal to the current SETTING, the user can proceed to the start scanning step 615, without having to change the SETTING of the feeder tray capacity level. If, however, the maximum (MAX) is not equal to the current SETTING, then the user will enter the new SETTING directly into the feeder tray capacity level setting box 202 using a mouse and keyboard (step 606). This will cause the feeder table lift/drive 304 to raise or lower the feeder table 120 to the user selected new SETTING for the feeder tray capacity level. When the desired new SETTING is achieved through step 606, the user can place the first stack of sheets in the feeder tray 120 and start the scanning process (step 615).

It should be understood that foregoing steps described with respect to FIGS. 7 and 8 are merely illustrative of the exemplary teachings herein, and various modifications could be made in the sequence of the steps and/or in the steps themselves, so long as a desired feeder tray capacity level setting can be entered by the user, and the feeder tray capacity level adjusted accordingly. For example, the current feeder tray capacity level setting need not be displayed to or determined by the user. The user simply could be prompted to enter the desired feeder tray capacity level setting, and upon doing so, the feeder tray can be adjusted accordingly, if need be.

While the foregoing discussion presents the teachings in an exemplary fashion with respect to a conventional scanner device, it will be apparent to those skilled in the art that the teachings may apply to any type of device that employs an automated sheet feeding system (e.g., fax machine, industrial scanner, printer, or a combined printer/scanner/fax machine) desiring or requiring variable feeder tray capacity control capability. Further, while the foregoing has described what are considered to be the best mode and/or other examples, it is understood that various modifications may be made therein and that the subject matter disclosed herein may be implemented in various forms and examples, and that the teachings may be applied in numerous applications, only some of which have been described herein.

What is claimed is:

1. A method for controlling the feeder tray capacity level of an automated document feeder, the method comprising the steps of:
setting a feeder tray capacity level to any desired level via an interface associated with the automated document feeder; and
positioning a feeder tray of the automated document feeder according to the set feeder tray capacity level.

2. The method of claim 1, wherein the step of positioning includes returning the feeder tray to the set feeder tray capacity level after feeding a batch of documents.

3. The method of claim 1, wherein the feeder tray capacity level is set via a hardware user interface associated with the automatic document feeder.

4. The method of claim 3, wherein the hardware user interface comprises an input device for setting of the feeder tray capacity level.

5. The method of claim 4, wherein the input device comprises at least one button, key, switch or dial.

6. The method of claim 1, wherein the feeder tray capacity level is set via a software user interface associated with the automatic document feeder.

7. The method of claim 6, wherein the software user interface comprises an input device for setting of the feeder tray capacity level.

8. The method of claim 7, wherein the input device comprises at least a mouse or keyboard.

9. The method of claim 1, wherein the automated document feeder is associated with a scanning device.

10. A method for controlling the feeder tray capacity level of an automated document feeder, the method comprising the steps of:
determining a desired feeder tray capacity level setting for the automated document feeder;
determining a current feeder tray capacity level setting of the automated document feeder;
changing the current feeder tray capacity level setting of the automated document feeder to the desired feeder tray capacity level setting when the current feeder tray capacity level setting is not equal to the desired feeder tray capacity level setting; and
positioning a feeder tray of the automated document feeder according to the desired feeder tray capacity level setting.

11. The method of claim 10, further comprising the steps of feeding one or more batches of documents, and returning the feeder tray to the desired feeder tray capacity level setting for each batch of documents.

12. The method of claim 10, wherein the step of changing comprises the step of using a hardware user interface associated with the automatic document feeder.

13. The method of claim 12, wherein the hardware user interface comprises an input device for setting the desired feeder tray capacity level.

14. The method of claim 13, wherein the input device comprises at least one button, key, switch or dial.

15. The method of claim 10, wherein the step of changing comprises the step of using a software user interface associated with the automatic document feeder.

16. The method of claim 15, wherein the software user interface comprises an input device for setting the desired feeder tray capacity level.

17. The method of claim 16, wherein the input device comprises at least a mouse or keyboard.

18. The method of claim 10, wherein the automated document feeder is associated with a scanning device.

19. An automated document feeder system comprising:
a document feeder;
a feeder tray for supporting and moving documents to the document feeder, the feeder tray having an adjustable feeder tray capacity level selectively set at any desired level between a lower tray limit and an upper tray limit;
a user interface associated with the automated document feeder system for presenting one or more controls that affect the operation of the automated document feeder system,
wherein at least one of the controls is for setting the feeder tray capacity level.

20. The system of claim 19, wherein the user interface is a hardware user interface associated with the automatic document feeder.

21. The system of claim 20, wherein the at least one of the controls for setting the feeder tray capacity level comprises at least one button, key, switch or dial.

22. The system of claim 19, wherein the user interface is a software user interface associated with the automatic document feeder.

23. The system of claim 22, wherein the at least one of the controls for setting the feeder tray capacity level comprises at least a mouse or keyboard.

24. The system of claim 19, wherein the automated document feeder is associated with a scanning device.

25. A method for controlling the feeder tray capacity level of an automated document feeder, the method comprising the steps of:
determining a feeder tray capacity level for a first batch of documents; and
returning a feeder tray to the determined feeder tray capacity level for each successive batch of documents.

26. A method for controlling the feeder tray capacity level of an automated document feeder, the method comprising the steps of:
determining a feeder tray capacity level for one batch of documents;
feeding the one batch of documents;
entering a feeder tray capacity level for a successive batch of documents during the feeding of the one batch of documents; and
positioning a feeder tray to the entered feeder tray capacity level setting for the successive batch of documents after the one batch of documents is fed.
